(19) United States
(12) Patent Application Publication
(10) Pub. No.: US 2007/0066729 A1
(43) Pub. Date: Mar. 22, 2007

(54) Scratch resistant coatings compositions

(76) Inventors: Ashutosh Sharma, Wappingers Falls, NY (US); Peter Solera, Suffern, NY (US); Sarah Kaspers, Scarsdale, NY (US)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 11/523,426

(22) Filed: Sep. 19, 2006

Related U.S. Application Data
(60) Provisional application No. 60/719,357, filed on Sep. 22, 2005.

(51) Int. Cl. C08K 5/20

(52) U.S. Cl. 524/230; 524/529

(57) ABSTRACT

Coatings compositions, for example oil or water based coatings with alkyd, acrylic, acrylic alkyd, polyester, phenolic, melamine, epoxy or polyurethane resins, are made scratch resistant by the incorporation therein of an additive combination of b) a carboxylic acid reagent functionalized olefin polymer or copolymer and c) a primary or secondary fatty acid amide. The present coatings exhibit good weatherability, scratch resistance, good gloss retention and are non-sticky. The carboxylic acid reagent functionalized olefin polymer is for example maleic anhydride grafted polypropylene or polyethylene, or is a reaction product of maleic anhydride and an alpha-olefin, or is a tallow alcohol ester of said maleic anhydride products. The fatty acid amide is for example oleyl palmitamide or stearyl erucamide.

This application claims the benefit under 35 USC 119(e) of U.S. Provisional Application Serial No. 60/719,357, filed Sep. 22, 2005, the disclosure of which is incorporated by reference.

The present invention is aimed at scratch resistant coatings compositions. The invention is also aimed at a method of imparting scratch resistance to coatings compositions by incorporating therein certain anti-scratch additives. The coatings compositions are for example alkyd, acrylic, acrylic alkyd, polyester, cross-linked epoxide, or polyurethane based. The coatings are useful for example as architectural coatings or as automobile finishes.

### BACKGROUND

Long chain alcohol functionalized maleic anhydride grafted polypropylene is disclosed in Polyolefins 2003, The International Conference of Polyolefins, February 24-February 26, Houston, Tex., as a processing aid for polyolefins.

U.S. Pat. No. 6,048,942 discloses thermoplastic olefin compositions comprising mar resistance additives selected from polysiloxanes, metal stearates, saturated fatty acid amides and unsaturated fatty acid amides.

JP2002338778 teaches a graft copolymer compositions comprising fatty acid amides.

U.S. Pat. No. 5,731,376 discloses polypropylene block copolymer with improved scratch resistance by inclusion of a polyorganosiloxane. The compositions may further include a fatty acid amide.

U.S. Pat. No. 5,585,420 teaches scratch resistant polyolefin compositions comprising a plate like inorganic filler. The compositions may further comprise high rubber ethylene-propylene copolymers, fatty acid amides, polyorganosiloxanes or epoxy resins.

JP2002003692 discloses polypropylene resin comprising fatty acid amides.

JP62072739 is aimed at molded articles for automobile parts made by compounding a specific polyolefin with a rubbery substance and a specific amount of mica of a specific particle size. The polyolefin consists of a certain polypropylene and a polyolefin modified with an unsaturated carboxylic acid (anhydride), for example maleic anhydride.

JP 63017947 is aimed at scratch resistant propylene polymer compositions.

JP 2001261902 is aimed at polypropylene resin compositions useful as molding material for preparation of interior trims.

U.S. published app. No. 2003/0004245 teaches blends of polyolefin and a reaction product of polyolefin and an alpha, beta unsaturated carboxylic ester, acid or anhydride.

Polyanhydride resins are described in a CPChem Specialty Chemicals data sheet of 2004.

### SUMMARY OF THE INVENTION

Disclosed is a coatings composition comprising

a) a film forming binder and

an amount effective to improve the scratch resistance of said coatings composition of an additive combination of

b) a carboxylic acid reagent functionalized olefin polymer or copolymer and

c) a primary or secondary fatty acid amide.

Also disclosed is a method for providing scratch resistance to a coatings composition comprising a) a film forming binder,

which method comprises incorporating into said coatings composition an effective amount of an additive combination of

b) a carboxylic acid reagent functionalized olefin polymer or copolymer and

c) a primary or secondary fatty acid amide.

### DETAILED DISCLOSURE

Coatings Composition

The binder can in principle be any binder which is customary in industry, for example those described in Ullmann's Encyclopedia of Industrial Chemistry, 5th Edition, Vol. A18, pp. 368-426, VCH, Weinheim 1991. In general, it is a film forming binder based on a thermoplastic or thermosetting resin, predominantly on a thermosetting resin. Examples thereof are alkyd, acrylic, acrylic alkyd, polyester, phenolic, melamine, epoxy and polyurethane resins and mixtures thereof.

Component a) can be a cold-curable or hot-curable binder; the addition of a curing catalyst may be advantageous. Suitable catalysts which accelerate curing of the binder are described, for example, in Ullmann's Encyclopedia of Industrial Chemistry, Vol. A18, p. 469, VCH Verlagsgesellschaft, Weinheim 1991.

The present coatings are for example employed as a top coat for automobiles or as a wood coating.

Preference is given to coatings compositions in which component a) is a binder comprising a functional acrylate resin and a crosslinking agent.

Examples of coatings compositions containing specific binders are:

1. paints based on cold- or hot-crosslinkable alkyd, acrylate, polyester, epoxy or melamine resins or mixtures of such resins, if desired with addition of a curing catalyst;

2. two-component polyurethane paints based on hydroxyl-containing acrylate, polyester or polyether resins and aliphatic or aromatic isocyanates, isocyanurates or polyisocyanates;

3. one-component polyurethane paints based on blocked isocyanates, isocyanurates or polyisocyanates which are deblocked during baking, if desired with addition of a melamine resin;

4. one-component polyurethane paints based on a trisalkoxycarbonyltriazine crosslinker and a hydroxyl group containing resin such as acrylate, polyester or polyether resins;

5. one-component polyurethane paints based on aliphatic or aromatic urethaneacrylates or polyurethaneacrylates having free amino groups within the urethane structure and melamine resins or polyether resins, if necessary with curing catalyst;

6. two-component paints based on (poly)ketimines and aliphatic or aromatic isocyanates, isocyanurates or polyisocyanates;

7. two-component paints based on (poly)ketimines and an unsaturated acrylate resin or a polyacetoacetate resin or a methacrylamidoglycolate methyl ester;

8. two-component paints based on carboxyl- or amino-containing polyacrylates and polyepoxides;

9. two-component paints based on acrylate resins containing anhydride groups and on a polyhydroxy or polyamino component;

10. two-component paints based on acrylate-containing anhydrides and polyepoxides;

11. two-component paints based on (poly)oxazolines and acrylate resins containing anhydride groups, or unsaturated acrylate resins, or aliphatic or aromatic isocyanates, isocyanurates or polyisocyanates;

12. two-component paints based on unsaturated polyacrylates and polymalonates;

13. thermoplastic polyacrylate paints based on thermoplastic acrylate resins or externally crosslinking acrylate resins in combination with etherified melamine resins;

14. paint systems based on siloxane-modified or fluorine-modified acrylate resins.

In addition, the coatings compositions according to the invention may comprise a light stabilizer of the sterically hindered amine type, the 2-(2-hydroxyphenyl)-1,3,5-triazine and/or 2-hydroxyphenyl-2H-benzotriazole type.

For example, the light stabilizers are
2-(2-Hydroxyphenyl)-2H-benzotriazoles, for example known commercial hydroxyphenyl-2H-benzotriazoles and benzotriazoles as disclosed in, U.S. Pat. Nos. 3,004,896; 3,055,896; 3,072,585; 3,074,910; 3,189,615; 3,218,332; 3,230,194; 4,127,586; 4,226,763; 4,275,004; 4,278,589; 4,315,848; 4,347,180; 4,383,863; 4,675,352; 4,681,905, 4,853,471; 5,268,450; 5,278,314; 5,280,124; 5,319,091; 5,410,071; 5,436,349; 5,516,914; 5,554,760; 5,563,242; 5,574,166; 5,607,987, 5,977,219 and 6,166,218 such as 2-(2-hydroxy-5-methylphenyl)-2H-benzotriazole, 2-(3,5-di-t-butyl-2-hydroxyphenyl)-2H-benzotriazole, 2-(2-hydroxy-5-t-butylphenyl)-2H-benzotriazole, 2-(2-hydroxy-5-t-octylphenyl)-2H-benzotriazole, 5-chloro-2-(3,5-di-t-butyl-2-hydroxyphenyl)-2H-benzotriazole, 5-chloro-2-(3-t-butyl-2-hydroxy-5-methylphenyl)-2H-benzotriazole, 2-(3-sec-butyl-5-t-butyl-2-hydroxyphenyl)-2H-benzotriazole, 2-(2-hydroxy-4-octyloxyphenyl)-2H-benzotriazole, 2-(3,5-di-t-amyl-2-hydroxyphenyl)-2H-benzotriazole, 2-(3,5-bis-α-cumyl-2-hydroxyphenyl)-2H-benzotriazole, 2-(3-t-butyl-2-hydroxy-5-(2-(ω-hydroxy-octa-(ethyleneoxy)carbonyl-ethyl)-, phenyl)-2H-benzotriazole, 2-(3-dodecyl-2-hydroxy-5-methylphenyl)-2H-benzotriazole, 2-(3-t-butyl-2-hydroxy-5-(2-octyloxycarbonyl)ethylphenyl)-2H-benzotriazole, dodecylated 2-(2-hydroxy-5-methylphenyl)-2H-benzotriazole, 2-(3-t-butyl-2-hydroxy-5-(2-octyloxycarbonylethyl)phenyl)-5-chloro-2H-benzotriazole, 2-(3-tert-butyl-5-(2-(2-ethylhexyloxy)-carbonylethyl)-2-hydroxyphenyl)-5-chloro-2H-benzotriazole, 2-(3-t-butyl-2-hydroxy-5-(2-methoxycarbonylethyl)phenyl)-5-chloro-2H-benzotriazole, 2-(3-t-butyl-2-hydroxy-5-(2-methoxycarbonylethyl)phenyl)-2H-benzotriazole, 2-(3-t-butyl-5-(2-(2-ethylhexyloxy)carbonylethyl)-2-hydroxyphenyl)-2H-benzotriazole, 2-(3-t-butyl-2-hydroxy-5-(2-isooctyloxycarbonylethyl)phenyl-2H-benzotriazole, 2,2′-methylene-bis(4-t-octyl-(6-2H-benzotriazol-2-yl)phenol), 2-(2-hydroxy-3-α-cumyl-5-t-octylphenyl)-2H-benzotriazole, 2-(2-hydroxy-3-t-octyl-5-α-cumylphenyl)-2H-benzotriazole, 5-fluoro-2-(2-hydroxy-3,5-di-α-cumyl-phenyl)-2H-benzotriazole, 5-chloro-2-(2-hydroxy-3,5-di-α-cumylphenyl)-2H-benzotriazole, 5-chloro-2-(2-hydroxy-3-α-cumyl-5-t-octylphenyl)-2H-benzotriazole, 2-(3-t-butyl-2-hydroxy-5-(2-isooctyloxycarbonylethyl)phenyl)-5-chloro-2H-benzotriazole, 5-trifluoromethyl-2-(2-hydroxy-3-α-cumyl-5-t-octylphenyl)-2H-benzotriazole, 5-trifluoromethyl-2-(2-hydroxy-5-t-octylphenyl)-2H-benzotriazole, 5-trifluoromethyl-2-(2-hydroxy-3,5-di-t-octylphenyl)-2H-benzotriazole, methyl 3-(5-trifluoromethyl-2H-benzotriazol-2-yl)-5-t-butyl-4-hydroxyhydrocinnamate, 5-butylsulfonyl-2-(2-hydroxy-3-α-cumyl-5-t-octylphenyl)-2H-benzotriazole, 5-trifluoromethyl-2-(2-hydroxy-3-α-cumyl-5-t-butylphenyl)-2H-benzotriazole, 5-trifluoromethyl-2-(2-hydroxy-3,5-di-t-butylphenyl)-2H-benzotriazole, 5-trifluoromethyl-2-(2-hydroxy-3,5-di-α-cumylphenyl)-2H-benzotriazole, 5-butylsulfonyl-2-(2-hydroxy-3,5-di-t-butylphenyl)-2H-benzotriazole and 5-phenylsulfonyl-2-(2-hydroxy-3,5-di-t-butylphenyl)-2H-benzotriazole;
Sterically hindered amine stabilizers, for example 4-hydroxy-2,2,6,6-tetramethylpiperidine, 1-allyl-4-hydroxy-2,2,6,6-tetramethylpiperidine, 1-benzyl-4-hydroxy-2,2,6,6-tetramethylpiperidine, bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl)n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butane-tetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decan-2,4-dione, bis(1-octyloxy-2,2,6,6-tetramethylpiperidyl)sebacate, bis(1-octyloxy-2,2,6,6-tetramethylpiperidyl) succinate, linear or cyclic condensates of N,N′-bis-(2,2,6,6-tetramethyl-4-piperidyl)-hexamethylenediamine and 4-morpholino-2,6-dichloro-1,3,5-triazine, the condensate of 2-chloro-4,6-bis(4-n-butylamino-2,2,6,6-tetramethylpiperidyl )-1,3,5-triazine and 1,2-bis(3-amino-propylamino)ethane, the condensate of 2-chloro-4,6-di-(4-n-butylamino-1,2,2,6,6-pentamethylpiperidyl)-1,3,5-triazine and 1,2-bis-(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidin-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensation product of N,N′-bis(2,2,6,6-tetramethyl-4-piperidyl)hexamethylenediamine and 4-cyclohexylamino-2,6-dichloro-1,3,5-triazine, a condensation product of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); N-(2,2,6,6-tetramethyl-4-piperidyl)-n-dodecylsuccinimid, N-(1,2,2,6,6-pentamethyl-4-piperidyl)-n-dodecylsuccinimid, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, diester of 4-methoxy-methylene-malonic acid with 1,2,2,6,6-pentamethyl-4-hydroxypiperidine, poly[methylpropyl-3-oxy-4-(2,2,6,6-tetramethyl-4-piperidyl)]siloxane, reaction product of maleic acid anhydride-α-olefin-copolymer with 2,2,6,6-tetramethyl-4-aminopiperidine, 1,2,2,6,6-pentamethyl-4-aminopiperidine or di-(1,2,2,6,6-pentamethylpiperidin-4-yl)p-methoxybenzylidenemalonate (CAS #147783-69-5);
The sterically hindered amine may also be one of the compounds described in U.S. Pat. No. 5,980,783, the relevant parts of which are hereby incorporated by reference, that is compounds of component I-a), I-b), I-c), I-d), I-e), I-f), I-g), I-h), I-i), I-j), I-k) or I-l), in particular the light stabilizer 1-a-1, 1-a-2, 1-b-1, 1-c-1, 1-c-2, 1-d-1, 1-d-2, 1-d-3, 1-e-1, 1-f-1, 1-g-1, 1-g-2 or 1-k-1 listed on columns 64-72 of said U.S. Pat. No. 5,980,783;
The sterically hindered amine may also be one of the compounds described in U.S. Pat. Nos. 6,046,304 and 6,297,299, the disclosures of which are hereby incorporated by reference, for example compounds as described in claims 10 or 38 or in Examples 1-12 or D-1 to D-5 therein;
Sterically hindered amines substituted on the N-atom by a hydroxy-substituted alkoxy group, for example compounds such as 1-(2-hydroxy-2-methylpropoxy)-4-octadecanoyloxy-2,2,6,6-tetramethylpiperidine, 1-(2-hydroxy-2-methylpropoxy)-4-hexadecanoyloxy-2,2,6,6-tetra-methylpiperidine, the reaction product of 1-oxyl-4-hydroxy-2,2,6,6-tetramethylpiperidine with a carbon radical from t-amylalcohol, 1-(2-hydroxy-2-methylpropoxy)-4-hydroxy-2,2,6,6-tetra-methylpiperidine, 1-(2-hydroxy-2-methylpropoxy)-4-oxo-2,2,6,6-tetramethylpiperidine, bis(1-(2-hydroxy-2-methylpropoxy)-2,2,6,6-tetramethylpiperidin-4-yl)sebacate, bis(1-(2-hydroxy-2-methylpropoxy)-2,2,6,6-tetramethylpiperidin-4-yl)adipate, bis(1-(2-hydroxy-2-methylpropoxy)-2,2,6,6-tetramethylpiperidin-4-yl)succinate, bis(1-(2-hydroxy-2-methylpropoxy)-2,2,6,6-tetra-methylpiperidin-4-yl)glutarate and 2,4-bis{N-[1-(2-hydroxy-2-methylpropoxy)-2,2,6,6-tetra-methylpiperidin-4-yl]-N-butylamino}-6-(2-hydroxyethylamino)-s-triazine; or
Tris-aryl-o-hydroxyphenyl-s-triazines, for example known commercial tris-aryl-o-hydroxyphenyl-s-triazines and triazines as disclosed in, U.S. Pat. Nos. 3,843,371; 4,619,956; 4,740,542; 5,096,489; 5,106,891; 5,298,067; 5,300,414; 5,354,794; 5,461,151; 5,476,937; 5,489,503; 5,543,518; 5,556,973; 5,597,854; 5,681,955; 5,726,309; 5,736,597; 5,942,626; 5,959,008; 5,998,116; 6,013,704; 6,060,543; 6,242,598 and 6,255,483, for example 4,6-bis-(2,4-dimethylphenyl)-2-(2-hydroxy-4-octyloxyphenyl)-s-triazine, Cyasorb® 1164, Cytec Corp, 4,6-bis-(2,4-dimethylphenyl)-2-(2,4-dihydroxyphenyl)-s-triazine, 2,4-bis(2,4-dihydroxyphenyl)-6-(4-chlorophenyl)-s-triazine, 2,4-bis[2-hydroxy-4-(2-hydroxyethoxy)phenyl]-6-(4-chlorophenyl)-s-triazine, 2,4-bis[2-hydroxy-4-(2-hydroxy-4-(2-hydroxyethoxy)phenyl]-6-(2,4-dimethylphenyl)-s-triazine, 2,4-bis[2-hydroxy-4-(2-hydroxyethoxy)phenyl]-6-(4-bromophenyl)-s-triazine, 2,4-bis[2-hydroxy-4-(2-acetoxyethoxy)phenyl]-6-(4-chlorophenyl)-s-triazine, 2,4-bis(2,4-dihydroxyphenyl)-6-(2,4-dimethylphenyl)-s-triazine, 2,4-bis(4-biphenylyl)-6-(2-hydroxy-4-octyl-oxycarbonylethylideneoxyphenyl)-s-triazine, 2-phenyl-4-[2-hydroxy-4-(3-sec-butyloxy-2-hydroxy-propyloxy)phenyl]-6-[2-hydroxy-4-(3-sec-amyloxy-2-hydroxypropyloxy)phenyl]-s-triazine, 2,4-bis(2,4-dimethylphenyl)-6-[2-hydroxy-4-(3-benzyloxy-2-hydroxypropyloxy)phenyl]-s-triazine, 2,4-bis(2-hydroxy-4-n-butyloxyphenyl)-6-(2,4-di-n-butyloxyphenyl)-s-triazine, 2,4-bis(2,4-dimethyl-phenyl)-6-[2-hydroxy-4-(3-nonyloxy*-2-hydroxypropyloxy)-5-α-cumylphenyl]-s-triazine (* denotes a mixture of octyloxy, nonyloxy and decyloxy groups), methylenebis-{2,4-bis(2,4-dimethylphenyl)-6-[2-hydroxy-4-(3-butyloxy-2-hydroxypropoxy)phenyl]-s-triazine}, methylene bridged dimer mixture bridged in the 3:5′, 5:5′ and 3:3′ positions in a 5:4:1 ratio, 2,4,6-tris(2-hydroxy-4-isooctyloxycarbonylisopropylideneoxyphenyl)-s-triazine, 2,4-bis(2,4-dimethylphenyl)-6-(2-hydroxy-4-hexyloxy-5-α-cumylphenyl)-s-triazine, 2-(2,4,6-trimethylphenyl)-4,6-bis[2-hydroxy-4-(3-butyloxy-2-hydroxypropyloxy)phenyl]-s-triazine, 2,4,6-tris[2-hydroxy-4-(3-sec-butyloxy-2-hydroxypropyloxy)phenyl]-s-triazine, mixture of 4,6-bis-(2,4-dimethylphenyl)-2-(2-hydroxy-4-(3-dodecyloxy-2-hydroxypropoxy)-phenyl)-s-triazine and 4,6-bis-(2,4-dimethylphenyl)-2-(2-hydroxy-4-(3-tridecyloxy-2-hydroxypropoxy)-phenyl)-s-triazine, Tinuvin® 400, Ciba Specialty Chemicals Corp., 4,6-bis-(2,4-dimethylphenyl)-2-(2-hydroxy-4-(3-(2-ethylhexyloxy)-2-hydroxypropoxy)-phenyl)-s-triazine and 4,6-diphenyl-2-(4-hexyloxy-2-hydroxyphenyl)-s-triazine.

The coatings compositions may also comprise further components, examples being solvents, pigments, dyes, plasticizers, stabilizers, thixotropic agents, drying catalysts and/or levelling agents. Examples of possible components are those described in Ullmann's Encyclopedia of Industrial Chemistry, 5th Edition, Vol. A18, pp. 429-471, VCH, Weinheim 1991.

Possible drying catalysts or curing catalysts are, for example, organometallic compounds, amines, amino-containing resins and/or phosphines. Examples of organometallic compounds are metal carboxylates, especially those of the metals Pb, Mn, Co, Zn, Zr or Cu, or metal chelates, especially those of the metals Al, Ti or Zr, or organometallic compounds such as organotin compounds, for example.

Examples of metal carboxylates are the stearates of Pb, Mn or Zn, the octoates of Co, Zn or Cu, the naphthenates of Mn and Co or the corresponding linoleates, resinates or tallates.

Examples of metal chelates are the aluminium, titanium or zirconium chelates of acetylacetone, ethyl acetylacetate, salicylaldehyde, salicylaldoxime, o-hydroxyacetophenone or ethyl trifluoroacetylacetate, and the alkoxides of these metals.

Examples of organotin compounds are dibutyltin oxide, dibutyltin dilaurate or dibutyltin dioctoate.

Examples of amines are, in particular, tertiary amines, for example tributylamine, triethanolamine, N-methyldiethanolamine, N-dimethylethanolamine, N-ethylmorpholine, N-methylmorpholine or diazabicyclooctane (triethylenediamine) and salts thereof. Further examples are quaternary ammonium salts, for example trimethylbenzylammonium chloride.

Amino-containing resins are simultaneously binder and curing catalyst. Examples thereof are amino-containing acrylate copolymers.

The curing catalyst used can also be a phosphine, for example triphenylphosphine.

The coatings compositions can also be radiation-curable coating compositions. In this case, the binder essentially comprises monomeric or oligomeric compounds containing ethylenically unsaturated bonds, which after application are cured by actinic radiation, i.e. converted into a crosslinked, high molecular weight form. Where the system is UV-curing, it generally contains a photoinitiator as well. Corresponding systems are described in the abovementioned publication Ullmann's Encyclopedia of Industrial Chemistry, 5th Edition, Vol. A18, pages 451-453.

The coatings compositions according to the invention can be applied to any desired substrates, for example to metal, wood, plastic or ceramic materials. They are for example used as a top coat in the finishing of automobiles.

Also disclosed is the use of present coatings compositions for protecting a wood surface, e.g. by incorporation of present components b) and c) into a varnish, paint, stain or impregnation on wood. The present invention therefore also pertains to a method for providing scratch and mar resistance to a wood surface, which method comprises applying a present coatings composition, especially a varnish, paint, stain or impregnation on wood. Components b) and c) may be applied as part of a stain or impregnation or as part of a top coat.

In case that the wood coating is a stain or impregnation, preferably a solvent is used selected e.g. from the group consisting of aliphatic hydrocarbons, cycloaliphatic hydrocarbons, aromatic hydrocarbons, alcohols, ethers, esters, ketones, glycols, glycol ethers, glycol esters, polyglycols or mixtures thereof. Preferably in this case the binder is selected from the group consisting of alkyd resins, modified alkyd resins, autocrosslinking or non-autocrosslinking acrylic resins, polyester resins, drying oils, phenolic resins, nitrocellulose or mixtures thereof.

Usual additives like fungicides or insecticides are possible. Exemplary of useful fungicides are tributyltin oxide, phenylmercury salts, copper naphthenate, 1-chloronaphthalene or pentachlorophenol. Exemplary of useful insecticides are DDT, dieldrin, lindane, azaconazol, cypermethin, benzalkoniumhydrochloride, propiconazol or parathion.

Any coating composition suitable for coating wood may be used as a top coat. It will normally contain a binder, dissolved or dispersed in an organic solvent or in water or a mixture of water and solvent. The binder may typically be a surface coating resin which dries in the air or hardens at room temperature. Exemplary of such binders are nitrocellulose, polyvinyl acetate, polyvinyl chloride, unsaturated polyester resins, polyacrylates, polyurethanes, epoxy resins, phenolic resins, and especially alkyd resins. The binder may also be a mixture of different surface coating resins. Provided the binders are curable binders, they are normally used together with a hardener and/or accelerator.

The top coat may also be a radiation-curable, solvent-free formulation of photopolymerizable compounds. Illustrative examples are mixtures of acrylates or methacrylates, unsaturated polyester/styrene mixtures or mixtures of other ethylenically unsaturated monomers or oligomers.

The top coat may contain a soluble dye and/or a pigment and/or a filler. The pigment may be an organic, inorganic or metallic pigment. The pigments may be opaque or transparent such as for example transparent iron oxides. The filler may be typically kaolin, calcium carbonate or aluminium silicate. Preferably the top coat is a clear varnish, i.e. it contains no undissolved components.

The present invention is particularly useful for the following applications: in home applications, such as furniture, wood floors, chipboards or timber work; outdoor applications such as fences, construction parts, wooden fronts, window frames and the like.

The present coatings compositions may be applied to the substrates by the customary methods, for example by brushing, spraying, pouring, dipping or electrophoresis; see also Ullmann's Encyclopedia of Industrial Chemistry, 5th Edition, Vol. A18, pp. 491-500.

Depending on the binder system, the coatings may be cured at room temperature or by heating. The coatings may for example be cured at 50-150° C., and in the case of powder coatings or coil coatings even at higher temperatures.

The coatings compositions can comprise an organic solvent or solvent mixture in which the binder is soluble. The coatings compositions can otherwise be an aqueous solution or dispersion. The vehicle can also be a mixture of organic solvent and water. The coating composition may be a high-solids paint or can be solvent-free (e.g. a powder coating material). Powder coatings are, for example, those described in Ullmann's Encyclopedia of Industrial Chemistry, 5th Ed., A18, pages 438-444. The powder coating material may also have the form of a powder-slurry (dispersion of the powder preferably in water).

The pigments can be inorganic, organic or metallic pigments. The present coatings compositions may contain no pigments and are used as a clearcoat.

Carboxylic Acid Reagent Functionalized Olefin Polymer or Copolymer

The olefin polymers or copolymers of the functionalized olefin polymers or copolymers of component b) are for example polypropylene homo- and copolymers and polyethylene homo- and copolymers. For instance, polypropylene, high density polyethylene (HDPE), linear low density polyethylene (LLDPE), polypropylene random and impact (heterophasic) copolymers, propylene/ethylene copolymers or ethylene-alpha-olefin copolymers.

The functionalized olefin polymers or copolymers are for example as disclosed in U.S. app. 2003/0004245, published Jan. 2, 2003, based on U.S. app. No. 10/041,056, filed Jan. 7, 2002, incorporated herein by reference.

The functionalized olefin polymers or copolymers are for example the reaction product of at least one polyolefin and at least one alpha, beta-unsaturated carboxylic acid reagent, such as an acid, ester or anhydride.

In one embodiment, the number average molecular weight of the polyolefins utilized in this component may range from about 2,000 to about 10,000. These polymers typically have a melt flow from about 8 to about 40, or from about 10 to about 35, or from about 15 to about 30 g/10 min. The amount of carboxylic acid reagent reacted with the polyolefin may range from about 0.5% to about 30% or from about 1% to about 20%, or from about 2% to about 15%, or from about 4% to about 10% by weight.

The alpha, beta unsaturated carboxylic reagent may be mono- or dicarboxylic acid reagent. The carboxylic reagents include carboxylic acids, esters and salts. The monobasic alpha, beta-unsaturated carboxylic acid reagents include acrylic, methacrylic, annamic, crotonic acids and esters, such as esters having from 1 to about 12 carbon atoms, and salts such as sodium, calcium or magnesium salts. Examples of dicarboxylic reagents include maleic acid, maleic anhydride, fumaric acid, mesaconic acid, himic anhydride, itaconic acid, citraconic acid, itaconic anhydride, citraconic anhydride, monomethyl maleate, monosodium maleate, etc. Particularly preferred alpha, beta-unsaturated carboxylic reagents are acrylic acid, methacrylic acid, acrylic esters, methacrylic esters and maleic anhydride.

The reaction between the carboxylic acid reagent and the olefin polymer or copolymer can be effected by means known to those skilled in the art. For example, the reaction can be conducted in solutions by a melt process in the presence of a free radical initiator. The free radical initiators usually are either peroxides or various organic azo compounds. The amount of initiator utilized generally from about 0.01% to about 5% by weight based on the combined weight of the polyolefin and the carboxylic reagent.

The reaction between the carboxylic acid reagent and the olefin polymer or copolymer is referred to as “grafting”. For example, the present functionalized olefin polymers or copolymers are olefin polymers or copolymers grafted with acrylic acid, methacrylic acid, methyl acrylate, methyl methacrylate, 2-hydroxypropyl methacrylate, butyl acrylate or maleic anhydride. In the case of for example grafting with maleic anhydride, this is termed “maleated”.

Examples of acrylated polyolefins are the POLYBOND polymers available from Uniroyal Chemical Company. A particularly useful polymer is POLYBOND 1002, which has a melt flow of 15-25 g/10 min and an acrylic acid content 5.5% to 7.0% by weight. An example of a commercially available maleic acid grafted polypropylene is Epolene E-43 wax from Eastman Chemical Products, Inc. Epolene E-43 has an acid number of 47 and an approximate number average molecular weight of 4500. Epolene C-16 and C-18 waxes are maleic acid grafted polyethylenes with approximate molecular weights of 8000 and 4000, respectively. Maleated ethylene-propylene elastomers also are useful, and such elastomers are available from Exxon Chemical Company under identification numbers 99-10, 99-14 and 99-26. These copolymers contain 77%, 64% and 43% of ethylene, respectively, and the maleated products contain 0.76%, 0.56% and 0.35% of maleic acid or anhydride, respectively.

Other examples of commercially available maleic acid anhydride grafted polyolefins include Kraton FG1901X from Shell which is often referred to as a maleated selectively hydrogenated SEBS copolymer; terpolymers available from CdF Chimie under designations such as Lotader 3200 (prepared from a mixture of 88% by weight ethylene, 9% by weight butyl acrylate and 3% maleic anhydride), Lotader 6600 (70% ethylene, 27% acrylic ester and 3% maleic anhydride) etc.; ethylene vinyl acetate copolymers grafted with maleic anhydride (EVA-MAH) are available from Quantum Chemical Corp.

Alternatively, the functionalized olefin polymers or copolymers of component b) are the reaction products of an alpha-olefin with an alpha, beta-unsaturated carboxylic acid reagent as described above. The reaction is effected by means known in the art. For example, the reaction can be conducted by a melt process in the presence of a free radical initiator. The radical initiators are for example peroxides or organic azo compounds. Again, the unsaturated carboxylic reagents are for example acrylic acid, methacrylic acid, acrylic esters methacrylic esters or maleic anhydride.

For instance, the alpha-olefin is from C₃ up to about C₃₃, for example the alpha-olefin is a C₁₈-C₂₆ alpha-olefin, for example a C₂₂₋₂₆ or a C₁₈ alpha-olefin.

For instance, the functionalized olefin is a maleated alpha-olefin, that is, the reaction product of an alpha-olefin and maleic anhydride. For example the maleated alpha-olefin is of the formula

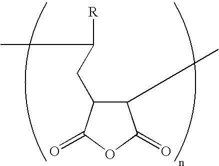

where

R is C₁₆ to C₂₄ alkyl and

n is an integer such that the average molecular weight is between about 20,000 and about 50,000.

The present functionalized olefin polymers or copolymers may be further reacted with a long chain alcohol or long chain amine as described in co-pending U.S. app. No. 11/058,499, filed Feb. 15, 2005, the disclosure of which is hereby incorporated by reference.

That is, the functionalized olefin polymers or copolymers may be reacted with a long chain alcohol or long chain amine to form the ester or amide or imide products.

These additives are termed long chain esters, amides or imides of the functionalized olefin polymers or copolymers. The long chain esters, amides or imides likewise fall under the present definition of carboxylic acid reagent functionalized olefin polymers or copolymers.

The carbon chain of the long chain alcohol or long chain amine is straight or branched and may be saturated or unsaturated. The amine is primary or secondary.

For example, the present functionalized olefin polymers or copolymers may be further reacted to form an ester, partial ester, or half ester product resulting from reaction with a long chain alcohol, or to form an amide, partial amide or imide product resulting from reaction with a long chain primary or secondary amine. Imides may be prepared by heating a half amide. The present functionalized olefin polymers or copolymers may be further reacted to form mixtures of esters and amides.

Half ester or partial ester derivatives may be formed by dropwise addition of alcohol to a stirred, acid catalyzed solution of the functionalized olefin polymer or copolymer in an appropriate solvent under conditions such that water is not removed from the reaction mixture. Appropriate solvent is for example methyl isobutyl ketone. Suitable acid catalysts include sulfuric acid, methanesulfonic acid, and p-toluenesulfonic acid. Diesters are prepared using excess alcohol and removing the water to drive the reaction towards full esterification.

For instance, the present long chain esters are esters or half esters of maleated alpha-olefin of the formula

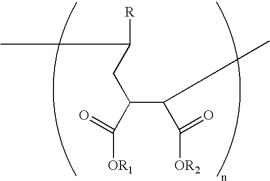

where

R is C₁₆ to C₂₄ alkyl,

R₁ and R₂ are independently hydrogen, C₁-C₂₂ alkyl or C₂-C₂₂ alkenyl

where at least one of R₁ and R₂ are C₁₂-C₂₂ alkyl or alkenyl and

n is an integer such that the average molecular weight is between about 20,000 and about 50,000.

For instance, the present long chain amides are amides of maleated alpha-olefin of the formula

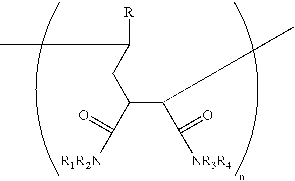

where

R is C₁₆ to C₂₄ alkyl,

R₁, R₂, R₃ and R₄ are independently hydrogen or C₁-C₂₂ alkyl or C₂-C₂₂ alkenyl,

where at least one of R₁, R₂, R₃ or R₄ are C₁₂-C₂₂ alkyl or alkenyl and

n is an integer such that the average molecular weight is between about 20,000 and about 50,000.

For instance, the present long chain imides are imides of maleated alpha-olefins of the formula

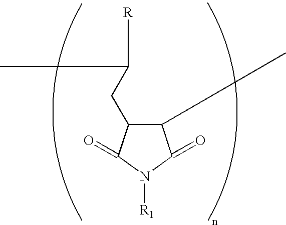

where

R is C₁₆ to C₂₄ alkyl,

R₁ is C₁₂-C₂₂ alkyl or alkenyl and

n is an integer such that the average molecular weight is between about 20,000 and about 50,000.

For example R is C₁₆ or is C₂₀₋₂₄.

For instance, the present long chain esters of the functionalized olefin polymer or copolymer are half esters or esters with tallow fatty alcohol, ricinoleyl alcohol [CAS# 540-11-4] or oleyl alcohol.

For example, the present long chain esters of the functionalized olefin polymer or copolymer are the half ester or ester reaction products of maleated olefin polymers or copolymers with the long chain alcohols.

For instance, the present long chain esters are the half ester or ester reaction products of maleated alpha-olefins with the long chain alcohols.

For instance, the present long chain amides are amide reaction products of maleated olefin polymers or copolymers or of maleated alpha-olefins with oleamide, erucamide, stearamide, behenamide, oleyl palmitamide, stearyl erucamide, ethylene-bis-stearamide or ethylene-bis-oleamide, or are the corresponding imides with oleamide, erucamide, stearamide or behenamide. That is, the amide or imide reaction products of maleated olefin polymers or copolymers or of maleated alpha-olefins with long chain amines.

For example, the present functionalized olefin polymer or copolymer is a long chain ester, long chain half ester, long chain amide, long chain partial amide or a long chain imide,

which ester, half ester, amide, partial amide or imide is formed by the reaction of a long chain alcohol or long chain primary or secondary amine of the formulae

R₁OH or R₁R₂NH, where R₁ is C₁₂-C₂₂alkyl or C₁₂-C₂₂alkenyl and R₂ is hydrogen, C₁-C₂₂alkyl or C₂-C₂₂alkenyl,

with an olefin polymer or copolymer grafted with an alpha, beta-unsaturated carboxylic acid reagent or

with a reaction product of an alpha-olefin with an alpha, beta-unsaturated carboxylic acid reagent.

Primary or Secondary Fatty Acid Amide

The primary or secondary fatty acid amides are for example where the fatty group of the fatty acids are C₁₁ to C₂₁ alkyl or alkenyl.

The primary or secondary fatty acid amide is for example at least one compound selected from the group consisting of oleamide, erucamide, stearamide, behenamide, oleyl palmitamide, stearyl erucamide, ethylene-bis-stearamide and ethylene-bis-oleamide.

In particular, the present fatty acid amides are secondary fatty acid amides, for example stearyl erucamide or oleyl palmitamide.

Suitable fatty acid amides are for example disclosed in U.S. Pat. No. 6,228,915, the relevant disclosures of which are hereby incorporated by reference.

Alkyl is straight or branched chain and is for example methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl, icosyl or docosyl.

Alkenyl is ethylenically unsaturated alkyl, for example allyl.

The weight:weight ratio of the functionalized olefin polymer or copolymer additive to the primary or secondary fatty acid amide additive is for example between about 20:1 and about 1:20, between about 10:1 and 1:10, between about 1:1 and about 20:1, for example between about 1:1 and about 15:1, between about 1:1 and about 10:1, between about 1:1 and about 7:1, or between about 1:1 and about 5:1. For instance, the weight:weight ration of the functionalized maleated alpha-olefin to the primary or secondary fatty acid amide is about 1.5:1, about 2:1, about 3:1, or about 4:1.

The total of the functionalized olefin polymer or copolymer b) and primary or secondary fatty acid amide additive c) combination to be incorporated into the coatings composition is for example between about 0.1% and about 15% by weight, based on the weight of the binder solids. For example, the additive combination is present from about 0.1% to about 10%, from about 0.3% to about 7%, or from about 0.3% to about 5% by weight, based on the weight of the binder solids. For instance, the present additive combination is present from about 0.1% to about 3%, from about 0.1% to about 5%, or from about 0.1% to about 7% by weight, based on the weight of the binder solids.

Nano-scaled fillers, or nanocomposites, may also be employed in the present compositions. Included are “nanoclays”, disclosed for example in U.S. Pat. Nos. 5,853,886 and 6,020,419, the relevant disclosures of which are hereby incorporated by reference.

Nano-scaled fillers are for example phyllosilicates or smectite clays, for example organophilic phyllosilicates, naturally occuring phyllosilicates, synthetic phyllosilicates or a mixture of such phyllosilicates. The present nano-scaled fillers are for example montmorillonites, bentonites, beidellites, hectorites, saponites or stevensites.

For example, nano-scaled montmorillonites have a “platey” or platelet structure. The platelets generally have a thickness below about 2 nm. The platelets or particles generally have an average diameter between about 20 and about 30,000 nm, and a ratio of length to width of between about 30,000:1 and 20:1. Commercially available nano-scaled montmorillonites of such structure are Nanomer® I.42E, available from Nanocor, and Cloisite® 30B, available from Southern Clay.

Nano-scaled fillers possess an extremely large surface with high surface energy. The deactivation of the surface energy and the compatibilization of the nano-scaled fillers with a polymer is therefore even more important than with a common micro-scaled filler in order to avoid coagulation and reach an excellent dispersion of the nano-scaled filled in the substrate. The nano-scaled fillers like the phyllosilicates are made organophilic by ion exchange, for example with alkylammonium salts. Such nano-scaled organophilic phyllosilicates are better swellable and easier to disperse in a polymer matrix.

Treated nano-scaled fillers are also referred to as “treated layered clay material” or “organoclay”.

The nano-scaled filler is present in the compositions of the present invention at a concentration of about 0.5 to about 10% by weight, based on the weight of the binder solids, for example, about 1 to about 9% by weight, for instance about 3 to about 7% by weight, for example about 5% by weight, based on the weight of the binder solids.

The following Examples illustrate the invention in more detail. Unless otherwise indicated, all percentages are in parts by weight.

Experimental

### EXAMPLE 1

The present functionalized olefin polymers b) are:

b1) polymer of C₂₂-C₂₆ alpha-olefin with maleic anhydride,

b2) tallow fatty alcohol ester of the polymer of C₂₂-C₂₆ alpha-olefin with maleic anhydride:

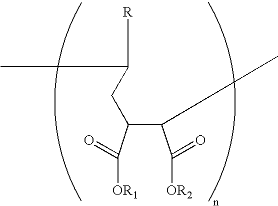

where

R₁ and R₂ are tallow, R is C₂₀-C₂₄ alkyl and n is an average value of about 45,

b3) maleic acid grafted polypropylene or

b4) tallow fatty alcohol ester of the maleic acid grafted polypropylene.

The present fatty acid amides of component c) are:

c1) stearyl erucamide or

c2) oleyl palmitamide.

A 2:1 weight:weight blend of the carboxylic acid reagent functionalized olefin polymer b) to the primary or secondary fatty acid amide c) is prepared. Likewise, 1:1 weight:weight blends and 1:2 weight:weight blends are prepared.

The components b) and c) are present at weight levels, in total, of 3%, based on the weight of the binder solids.

Other additives evaluated for comparative performance are oleamide, stearyl erucamide and Dow Corning MB 50-321 polysiloxane additive. Weight percents are on the binder solids.

Several tests are performed to evaluate scratch resistance before and after weathering, in addition to impact properties.

Standard Five Finger Scratch test guidelines (Daimler Chrysler Corporation Test Number LP-463DD-18-1, dated 2002-07-24)

| Rating | Scratch Width | Whitening |
|---|---|---|
| 1 (best) | <0.2 mm wide, | none |
| | almost invisible | |
| 2 | 0.2-0.3 mm wide, slight | none |
| | deformation, visible at close range | |
| 3 | 0.3-0.4 mm wide, clearly | |
| | visible | |
| 4 | 0.4-0.5 mm wide | visible whitening |
| | | over entire scratch |
| 5 (worst) | >0.5 mm wide | white over entire scratch |
| | | and possibly |
| | | accompanied by debris |

The present inventive blends provide for excellent scratch resistance and non-sticky.

Results after Weathering

In a separate detailed study, results are shown after weathering. Xenon arc WeatherOmeter at 0.55 W/m² irradiance (340 nm), SAE J 1885-NAFTA interior automotive protocol, 89° C. black panel temperature, dry conditions. Scratch resistance to 600 kJ/m² is desirable. Standard five-finger test ratings are measured.

After 600 KJS weathering, the present inventive blends exhibit outstanding scratch resistance.

Coatings containing stearyl erucamide alone become sticky after exposure to 600KJS. The inventive blend gives a surprising synergistic effect without any adverse effect upon weathering. That is, the inventive blends provide for excellent scratch resistance and weathering stability, and are non-sticky.

Present coatings tested for scratch resistance are:

tung oil phenolic varnish applied to cedar panels,

an aromatic urethane varnish applied to cedar panels,

a white two-component polyester urethane gloss enamel sprayed onto steel panels that are primed with an epoxy polyamide primer,

an acrylic alkyd refinish enamel, pigmented with aluminum pigment and sprayed onto steel panels primed with an alkyd primer,

a medium oil alkyd enamel pigmented with aluminum pigment and sprayed onto steel panels primed with an epoxy primer,

an acrylic alkyd crosslinked with an aliphatic isocyanate refinish enamel sprayed onto steel panels primed with an alkyd primer,

an alkyd paint sprayed onto steel panels primed with an epoxy primer and

a thermoplastic acrylic lacquer sprayed onto steel panels primed with an alkyd.

The present coatings also contain a hindered amine light stabilizer and a benzotriazole or s-triazine UV absorber.

Modified Taber Abrasion Test

Visual Inspection Guidelines

| Rating | Scratch Width | Relative Performance |
|---|---|---|
| 1 (best) | <50 mm | excellent |
| 2 | 200-300 mm | good |
| 3 | 300-400 mm | fair |
| 4 | 400-500 mm | poor |
| 5 (worst) | >500 mm | very poor |

The present inventive blends provide for excellent abrasion resistance according to the Taber Abrasion Test.

The present inventive additive blends provide for excellent impact strength according to the Notched Izod Impact test.

What is claimed is:

1. A coatings composition comprising
a) a film forming binder and
an amount effective to improve the scratch resistance and light stability of said coatings composition of an additive combination of
b) a carboxylic acid reagent functionalized olefin polymer or copolymer and
c) a primary or secondary fatty acid amide.

2. A composition according to claim 1 where the binder is selected from the group consisting of alkyd, acrylic, acrylic alkyd, polyester, phenolic, melamine, epoxy and polyurethane resins.

3. A composition according to claim 1 where the binder is an alkyd, acrylic or an acrylic alkyd resin.

4. A composition according to claim 1 where the binder is an acrylic resin.

5. A composition according to claim 1 where the functionalized olefin polymer or copolymer is an olefin polymer or copolymer grafted with an alpha, beta-unsaturated carboxylic acid reagent.

6. A composition according to claim 1 where the functionalized olefin polymer or copolymer is an olefin polymer or copolymer grafted with an alpha, beta-unsaturated carboxylic acid reagent selected from the group consisting of acrylic acid, methacrylic acid, methyl acrylate, methyl methacrylate, 2-hydroxypropyl methacrylate, butyl acrylate and maleic anhydride.

7. A composition according to claim 1 where the functionalized olefin polymer or copolymer is an olefin polymer or copolymer grafted with maleic anhydride.

8. A composition according to claim 1 where the functionalized olefin polymer or copolymer is polypropylene or polyethylene grafted with maleic anhydride.

9. A composition according to claim 1 where the functionalized olefin polymer or copolymer is the reaction product of an alpha-olefin with an alpha, beta-unsaturated carboxylic acid reagent.

10. A composition according to claim 1 where the functionalized olefin polymer or copolymer is the reaction product of an alpha-olefin with an alpha, beta-unsaturated carboxylic acid reagent selected from the group consisting of acrylic acid, methacrylic acid, methyl acrylate, methyl methacrylate, 2-hydroxypropyl methacrylate, butyl acrylate and maleic anhydride.

11. A composition according to claim 1 where the functionalized olefin polymer or copolymer is the reaction product of a C₁₈-C₂₆ alpha olefin and maleic anhydride.

12. A composition according to claim 1 where the functionalized olefin polymer or copolymer is a long chain ester, long chain half ester, long chain amide, long chain partial amide or long chain imide,
which ester, half ester, amide, partial amide or imide is formed by the reaction of a long chain alcohol or long chain primary or secondary amine of the formulae
R₁OH or R₁R₂NH, where R₁ is C₁₂-C₂₂alkyl or C₁₂-C₂₂alkenyl and R₂ is hydrogen, C₁-C₂₂alkyl or C₂-C₂₂alkenyl,
with an olefin polymer or copolymer grafted with an alpha, beta-unsaturated carboxylic acid reagent or
with a reaction product of an alpha-olefin with an alpha, beta-unsaturated carboxylic acid reagent.

13. A composition according to claim 1 where the functionalized olefin polymer or copolymer is the half ester or ester of maleated polypropylene, maleated polyethylene or maleated C₁₈-C₂₆ alpha-olefin with tallow fatty alcohol, ricinoleyl alcohol or oleyl alcohol.

14. A composition according to claim 1 where the fatty acid amide is stearyl erucamide or oleyl palmitamide.

15. A composition according to claim 1 where the weight:weight ratio of the functionalized olefin polymer or copolymer to the primary or secondary fatty acid amide is between about 1:1 and about 20:1.

16. A composition according to claim 1 where the weight:weight ratio of the functionalized olefin polymer or copolymer to the primary or secondary fatty acid amide is between about 1:1 and about 5:1.

17. A composition according to claim 1 where the total of the functionalized olefin polymer or copolymer and the primary or secondary fatty acid amide additive combination is between about 0.1% and about 10% by weight, based on the weight of the binder solids.

18. A composition according to claim 1 where the total of the functionalized olefin polymer or copolymer and the primary or secondary fatty acid amide additive combination is between about 0.1% and about 5% by weight, based on the weight of the binder solids.

19. A composition according to claim 1 further comprising one or more additives selected from the group consisting of the hindered amine light stabilizers and the hydroxyphenylbenzotriazole or hydroxyphenyl-s-triazine ultraviolet light absorbers.

20. A method for providing scratch resistance to a coatings composition comprising a) a film forming binder,
which method comprises incorporating into said coatings composition an effective amount of an additive combination of
b) a carboxylic acid reagent functionalized olefin polymer or copolymer and
c) a primary or secondary fatty acid amide.
